(19) United States
(12) Patent Application Publication
(10) Pub. No.: US 2013/0206267 A1
(43) Pub. Date: Aug. 15, 2013

(54) FLAME RESISTANT HOSE COUPLING

(71) Applicant: DAVID William LITCHFIELD, Midlothian, VA (US)

(72) Inventor: DAVID William LITCHFIELD, Midlothian, VA (US)

(73) Assignee: E. I. DU PONT DE NEMOURS AND COMPANY, Wilmington, DE (US)

(21) Appl. No.: 13/371,571

(22) Filed: Feb. 13, 2012

(51) Int. Cl. F16L 11/00; F16L 33/01

(52) U.S. Cl. 138/103; 285/222.1

(57) ABSTRACT

A hose and coupling combination wherein the hose is made of an inner tube which is enclosed by a reinforcing section which is further enclosed by a flame-resisting section and the coupling is made of inner sleeve with an outer sleeve adjacent to and enclosing a linear portion of the inner sleeve and arranged such that the outer sleeve and the inner sleeve form a cavity into which the flame-resisting section fits such that a gap is provided between the reinforcing section and the flame-resisting section.

### BACKGROUND OF THE INVENTION

1. Field of the Invention

This invention relates to devices for increasing heat and flame resistance in hoses.

2. Description of the Related Art

Couplings for hoses that convey flammable liquids in motor vehicles need some degree of fire resistance because exposure to excessive heat or flame can compromise the burst resistance of the hoses. Typical flammable liquids include gasoline, diesel fuel and aromatic or alkyl-based fuels. Situations may arise in which materials are exposed to flame or temperatures above the thermal limit of inherent stability. An example is brake failure as a result of a hose component in the brake fluid circuit failing due to exposure of the hose to a high heat event, such as a fire onboard a moving vehicle.

Such hoses may be made of a rubber tube, surrounded by a reinforcing layer of textile fabric, which is in turn surrounded by an outer wire braid layer. Conventionally, pressure retention of the hose relied on the strength of the textile fiber that may be exposed to heat and or flame, in which case heat is conducted through the outer steel wire braid to the textile braid layer and subsequently to the inner tube. Such hose configurations of materials relied on thermal contact resistance as the limitation to thermal conduction through the structure.

It is believed that when subjected to flame, the steel wire acts as a diffuser and prevents direct flame contact with the underlying textile braid, however there remains significant room for improvement to the heat or flame resistance of these hoses.

### BRIEF DESCRIPTION OF THE DRAWINGS

FIG. 1A shows a longitudinal section of a hose coupling.

FIG. 1B shows a longitudinal section of coupling joined to one end of a hose.

FIG. 2 shows a longitudinal section of a hose with a spacer.

### DETAILED DESCRIPTION OF THE INVENTION

In various embodiments, the invention is useful for prolonging the life of hoses exposed to flame by the introduction of some means to position a flame barrier material at a distance from the hose cover, thereby producing a gap that significantly increases the thermal contact resistance to conductive and convective heat transfer. Prolonged exposure to high temperature has negative effects on textile fiber strength over time. Therefore, in various embodiments, the invention permits the development of hoses that last longer under pressure when exposed to flame because heat flux to certain components of the hoses is significantly reduced. This represents an improvement in safety in the event of a fire in the engine compartment of a motor vehicle and particularly when the hoses are conveying gasoline.

The construction is intended to increase the thermal contact resistance by locating a flame-resistant barrier layer at some distance from the reinforcing layer, thereby creating an air gap. This provides for heat to be transferred through the air gap to the reinforcing layer with the air gap having a significantly lower thermal conductivity than a material such as steel that may be used in the flame-resistant layer. Because the flame resistant layer does not carry a significant a load circumferentially during pressurization, it can be braided or woven at a speed optimal for manufacturing and hose bending properties, which can result in savings during manufacture.

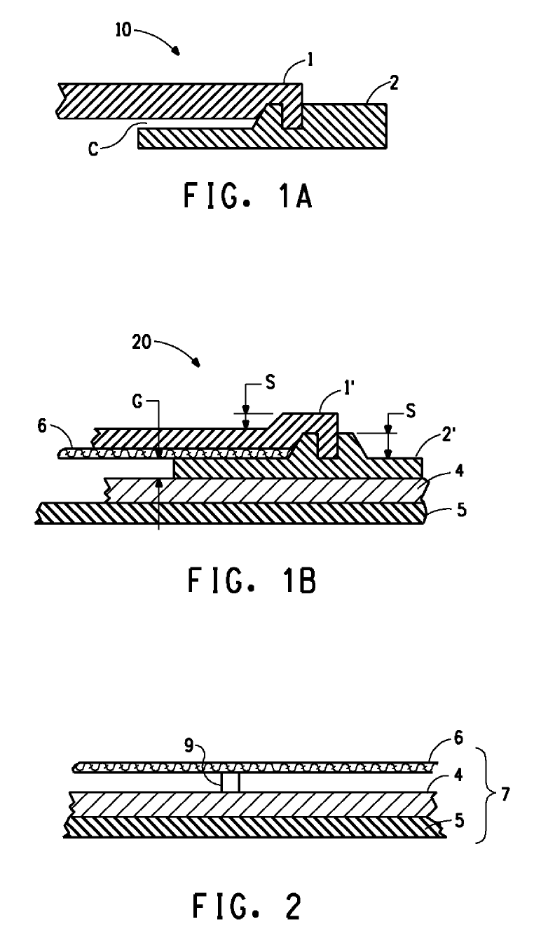

Although the figures presented herein are based on the hose and coupling as cylindrical, it is understood that the invention is not necessarily limited to that configuration. For example, the hose may be bent or formed to a given shape to fit an under-hood automotive application. FIG. 1A shows a coupling 10 having an outer sleeve 1 and an inner sleeve 2. In contrast to conventional couplings, the outer sleeve and the inner sleeve form a cavity C. Alternatively, and not shown in the figure, the cavity can be machined or otherwise provided as a one-piece coupling without the need for separate inner and outer sleeves.

As depicted in FIG. 2, hose 7 comprises a flame barrier layer 6, a reinforcing layer 4 and an inner layer 5. The flame barrier layer 6 fits into cavity C and provides air gap G by sliding the inner sleeve 2 (in FIG. 1A) to a desired position along the hose for flame protection and clamping sleeve 2 by mechanical or adhesion means for appropriate contact along cavity C to maintain the function of the hose. Outer sleeve 1 (in FIG. 1A) is positioned onto inner sleeve 2 and swaged, crimped or otherwise compressed uniformly at an adequate pressure to restrain the flame barrier layer 6 without disturbing reinforcement layer 4 and inner layer 5. FIG. 1B shows a device 20 comprising a coupling joined to a free length of hose 7, wherein the coupling consists of outer sleeve 1′ and inner sleeve 2′ indicating by areas S that both sleeves have been swaged or crimped to secure hose 7.

Hoses used with the inventive couplings typically have a steel wire over braid as the flame barrier layer and although it may provide some mechanical benefit, its more important function is to act as a diffuser when subjected to flames and to prevent direct flame contact with the underlying reinforcement layer, which is typically a textile braid. The cavity in the coupling has a different and preferably shorter length than the length of the sleeves which enables the compression of the flame barrier axially and thereby generates a radial expansion to facilitate the development of the air gap. The air gap greatly reduces the thermal energy transfer rate from the heated flame barrier (which may be directly exposed to flame) to the reinforcing layer. Heat conduction to the reinforcing layer will then depend on the conduction of heat from the flame barrier layer to the air gap, as well as radiant heating from the flame barrier layer to the reinforcing layer. In either mode or combination of modes, the rapid thermal energy transfer mechanism of conduction will be substantially limited by the presence of a low thermal conductivity medium (such as air in the gap) provided by the coupling as described herein. The couplings may be made of metal or organic polymer materials of suitable flame and heat resistance and is a suitable attachment to either corrugated or smooth-bore hoses with a steel wire braid on the outside of a layer of textile reinforcement and an inner tube that is typically made of rubber. The couplings may be used at either one end or both ends of a hose as deemed necessary. For example, the flame resistant layer may free float in cavity C at one end of the hose in order to provide greater lifetime of the barrier layer in circumstances of high axial vibration of the hose or high flexing of the hose. In some hoses, a cover layer (not shown) may be present to provide protection as well as additional reinforcement to reinforcing layer 4.

The air gap achieved with the inventive coupling may be desirable throughout the length of a hose and some means of maintaining that gap at locations relatively distant from the coupling may be required in some instances. To that end, FIG. 2 shows a solution to potential surface contact of the flame barrier with the reinforcement layer, which would lessen the advantages described in this invention. A spacer 9 having an inner diameter large enough to slide over the reinforcement layer 4 and of outer diameter large enough to maintain the desired air gap between the flame barrier 6 and the reinforcement layer 4 can be used. The spacers can be used in multiple places as required and are constructed of materials having high thermal stability and low thermal conductivity.

An advantage of the inventive hose/coupling combination is that it has higher thermal protection for the reinforcing layer, which is the primary load-carrying member for tube pressure resistance, to extend hose working or conveyance integrity in the event of a sustained exposure of the hose to flame. Further, the thermal protection is provided without adding significant weight and does not require additional layers of specialized (and typically expensive) materials. Moreover, there is no significant increase in the difficulty of securing the hose structure and end-connections by the use of specialized teeth and the minimum bending radius of the hose is not significantly impacted.

What is claimed is:

1. A coupling adapted for use with a hose having a plurality of layers, wherein the coupling comprises an inner sleeve and an outer sleeve arranged such that the outer sleeve and the inner sleeve form a cavity suitable for receiving at least one of the plurality of layers of the hose.

2. A device comprising a hose and coupling, wherein the hose comprises an inner tube which is enclosed by a reinforcing section which is further enclosed by a flame-barrier section and the coupling comprising an inner sleeve with an outer sleeve adjacent to and enclosing a linear portion of the inner sleeve and arranged such that the outer sleeve and the inner sleeve form a cavity and wherein the flame-barier section fits into the cavity such that a gap is provided between the reinforcing section and the flame barrier section.

3. The device according to claim 2, comprising a spacer for maintaining the gap at locations at a distance from the hose and coupling connection, wherein at such locations the gap would be otherwise smaller than at or near the hose and coupling connection.
